(19) United States
(12) Patent Application Publication
(10) Pub. No.: US 2007/0238833 A1
(43) Pub. Date: Oct. 11, 2007

(54) Polyamide composition comprising a modifier

(76) Inventors: Christian Leboeuf, Kingston (CA); Chun Sing Wong, Kingston (CA)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/732,331

(22) Filed: Apr. 3, 2007

Related U.S. Application Data
(60) Provisional application No. 60/790,614, filed on Apr. 10, 2006.

(51) Int. Cl. C08L 77/00

(52) U.S. Cl. 525/178

(57) ABSTRACT

A composition is disclosed which comprises a polyamide, a modifier, and optionally an ABS copolymer, a compatibilizer, or both wherein the modifier includes ethylene copolymer, crosslinked ethylene copolymer, ionomer derived from the ethylene copolymer, crosslinked ionomer derived from the ethylene copolymer, poly(meth)acrylate, or combinations of two or more thereof. The ethylene copolymer can comprise repeat units derived from ethylene, at least one alkyl acrylate or (meth)acrylic acid, and optionally an acid cure site.

This application claims priority to U.S. provisional application Ser. No. 60/790,614, filed Apr. 10, 2006, entire disclosure of which is incorporated herein by reference.

The invention relates to a composition comprising polyamide and a modifier or toughener and to processes therefor and therewith.

Though polyamides are regarded as tough, i.e., have good elongation, high energy to break, high tensile impact strength, and high energy absorption. Polyamides are also known to lack resistance to crack propagation such as, for example, notch sensitivity, brittle breaks, and failure of molded or extruded parts. The tendency of polyamides to break in a brittle rather than ductile fashion can be a limitation of utility.

Polyamides having improved impact strength have been developed using toughening additives. See, e.g., GB998,439, U.S. Pat. No. 3,845,163, U.S. Pat. No. 3,388,186, U.S. Pat. No. 3,465,059, U.S. Pat. No. 3,668,274, and U.S. Pat. No. 4,174,358. However, there is an increasing need to develop an improved polyamide composition because the known toughened polyamide compositions from time to time fail to deliver the required attributes such as heat resistance, chemical resistance, hydrolysis resistance, or dimensional stability.

Acrylate polymers such as Vamac®, which are commercially available from E. I. du Pont de Nemours and Company, Delaware (DuPont), especially those containing high levels (>50 weight %) of acrylate comonomer, may be tacky and tend to mass. They are available commercially only in bale forms. They are typically used in the rubber industries with equipments such as roll mills and Banbury mixers. Though they can be formed into pellets, upon storage, even after just a few hours, the pellets tend to fuse together and to form an intractable mass of polymer thereby rendering these copolymers difficult to handle under typical extrusion processes for thermoplastics, for the purpose of blending or forming, as in such processes the polymers are generally fed through either volumetric or loss-in-weight feeders. Since in the pellet form they are not free-flowing by nature, compounders and converters cannot handle them unless their process is designed to include specific auxiliary equipment that is suited for that purpose, hence the advantage for compounders to have access to a free-flowing form of the Vamac® copolymers. Though coating of the pellets with a partitioning agent such as talc may temporary reduce tackiness and massing, the pellets mass on storage due to cold flow of the Vamac® and render the product not usable in conventional thermoplastic resin feeders.

### SUMMARY OF THE INVENTION

The invention includes a composition comprising, consisting essentially of, or consisting of, a polyamide, a modifier, and optionally an ABS copolymer, a compatibilizer, or both.

### DETAILED DESCRIPTION OF THE INVENTION

Polyamide include both polymers comprising repeating units derived from monomers, such as caprolactam, which polymerize to form a polyamide, and copolymers derived from the copolymerization of caprolactam with a comonomer which when polymerized alone does not result in the formation of a polyamide. Polyamides include aliphatic polyamides such as polyamide 6, polyamide 9, polyamide 10, polyamide 11, polyamide 12, polyamide 6,6, polyamide 6,6/6, polyamide 6,9, polyamide 6,10, and polyamide 6,12 and polyamides prepared from 2,2-bis-(p-aminocyclohexyl)propane; and aromatic or partially aromatic polyamides, also referred to as high temperature nylons, such as polyamide 6I, polyamide 6T, polyamide 6I,6T, and polyamide MXD6 (comprising m-xylylenediamine and adipic acid moieties), polyamides made from terephthalic acid and/or isophthalic acid and trimethylhexamethylenediamine as well as those made from adipic acid, azelaic acid, from terephthalic acid and 4,4′-diaminocyclohexylmethane, and those made from terephthalic acid, hexamethylene diamine and 2-methyl pentamethylene diamine (2-MPMD) (also known as DYTEK A® from DuPont), 6T/DT, polyamides made from terephthalic acid, adipic acid and hexamethylene diamine, 66/6T, one or more copolymers thereof; and combinations of two or more thereof.

Polyamides may be made by any known method, including the polymerization of a monoamino monocarboxylic acid or a lactam thereof having at least two carbon atoms between the amino group and carboxylic acid group, of substantially equimolar proportions of a diamine which contains at least two carbon atoms between the amino groups and a dicarboxylic acid, or of a monoaminocarboxylic acid or a lactam thereof as define above, together with substantially equimolar portions of a diamine and a dicarboxylic acid. This dicarboxylic acid may be used in the form of a functional derivative thereof, for example, a salt, an ester or acid chloride.

Polyamides, often referred to as “nylons”, can be made by any well-known methods such as disclosed in U.S. Pat. Nos. 4,732,938; 4,659,760; and 4,315,086, the description of which is omitted herein for the interest of brevity.

The modifier can be an ethylene copolymer, crosslinked ethylene copolymer, ionomer derived from the ethylene copolymer, crosslinked ionomer derived from the ethylene copolymer, a poly(meth)acrylate, or combinations of two or more thereof.

An ethylene copolymer can comprise repeat units derived from ethylene and one or more alkyl (meth)acrylates or (meth)acrylic acid, and optionally an acid cure site monomer. (Meth)acrylate refers to acrylate, methacrylate, or both. (Meth)acrylic acid refers to acrylic acid, methacrylic acid, or both. Alkyl acrylate includes one or more C₁ to C₁₀ acrylates such as methyl acrylate, ethyl acrylate, n-butyl acrylate, iso-butyl acrylate, methoxymethyl acrylate, 2-ethylhexyl acrylate, octyl acrylate, methyl methacrylate, ethyl methacrylate, n-butyl methacrylate, iso-butyl methacrylate, methoxymethyl methacrylate, 2-ethylhexyl methacrylate, octyl methacrylate, or combinations of two or more thereof. Repeat units derived from alkyl (meth)acrylate can be about 5 to about 60, about 10 to about 50, or about 10 to about 40, weight % of the copolymer. The acid cure site monomer may be an acid, an acid anhydride, an ester of the acid such as monoalkyl ester. The acid can be an 1,4-butene-dioic acid, and its esters, which can exist in either cis or trans form, such as maleic acid, fumaric acid, maleic acid methyl ester, maleic acid ethyl ester, maleic acid propyl esters, maleic acid butyl esters, maleic acid pentyl ester, maleic acid hexyl esters, fumaric acid methyl ester, fumaric acid ethyl ester, fumaric acid propyl ester, or combinations of two or more thereof. Repeat units derived from acid cure site monomer can comprise from about 0.1 to about 10, about 0.5 to about 7, about 1 to about 6, or 2 to 5 weight % of the ethylene copolymer. The rest can be derived from ethylene. The quantities repeat units derived from alkyl (meth)acrylate(s) and the acid cure site monomer can be adjusted to provide the required amount of —CO₂— units in the final copolymer. The total —CO₂— units in the polymer are the sum of the ester groups in the two or more acrylate comonomers and in the 1,4-butene-dioic acid monoalkyl ester, and the acid groups in the monoalkyl ester.

An ethylene copolymer can also comprise repeat units derived from ethylene, (meth)acrylic acid, 0.1 to 15 weight % of a dicarboxylic acid, and optionally an alkyl acrylate (disclosed above) as disclosed in U.S. Pat. No. 5,859,137, the disclosure of which is incorporated herein by reference.

The ethylene copolymer can also be 0 to 100% neutralized with one or more zinc ions, sodium ions, calcium ions, lithium ions, antimony ions, potassium ions, or combinations of two or more thereof.

Examples of ethylene copolymers include copolymers of ethylene, methyl acrylate, and n-butyl acrylate, copolymers of ethylene, methoxymethyl acrylate (MMA), and n-butyl acrylate, copolymers of ethylene, methyl acrylate, and maleic acid ethyl monoester, copolymers of ethylene, methyl acrylate, n-butyl acrylate, and maleic acid ethyl monoester, copolymers of ethylene, methyl acrylate, iso-butyl acrylate, and maleic acid ethyl monoester, copolymers of ethylene, methyl acrylate, and 2-ethylhexyl acrylate. Copolymers of ethylene, methyl acrylate, 2-ethylhexyl acrylate, and maleic acid ethyl monoester, copolymers of ethylene, methyl acrylate, and n-octyl acrylate, and copolymers of ethylene, methyl acrylate, n-octyl acrylate, and maleic acid ethyl monoester.

The ethylene copolymers can be readily prepared using any methods known to one skilled in the art such as, for example, disclosed in U.S. Pat. Nos. 2,897,183, 3,883,472, 3,904,588, 4,174,358, and 5,028,674 as well as US patent application US2005/0020775, disclosures of which are incorporated herein by reference.

The ethylene copolymers can be mixed with additional materials, a process known in the art as compounding, to provide a blended composition. For example, compounding can involve combining the polymer with one or more additives such as antioxidants, internal release agents, plasticizers, accelerators, fillers (e.g., glass fibers, mica, etc.), flame retardants, or combinations of two or more thereof. Flame retardant can include any flame retardants known to one skilled in the art such as brominated polystyrene or poly (bromostyrene) (optionally with a flame retardant synergist such as antimony pentoxide, antimony trioxide, sodium antimonite, or Zinc Borate), phosphorus-containing compounds, a copolymer of a halostyrene and glycidyl(meth)acrylate, or a halogen-free thermoplastic polymer blend comprising an ethylene vinyl acetate carbon monoxide terpolymer, an ethylene vinyl acetate copolymer or a polyolefin, each of which is grafted with a carboxylic acid or anhydride thereof, and an inorganic filler. The components can be mixed in conventional equipment such as an internal mixer (e.g., a Banbury mixer), a two-roll mill and other similar mixing devices known in the art to achieve a substantially homogeneous mixture.

After compounding, a blend of the uncrosslinked copolymer and a curing agent, such as a peroxide curing system composing peroxide and optionally a coagent, along with one or more fillers and/or other additives disclosed can be subject to a curing step at sufficient time, temperature and pressure to achieve covalent chemical bonding (i.e., crosslinking). Suitable peroxides and coagents include any such curative system as generally known in the art (e.g., U.S. Pat. Nos. 2,897,183, 3,883,472, 3,904,588, 5,028,674, and 7,001,957 as well as US patent application US2005/0020775) including peroxide α,α-bis(t-butylperoxy)-diisopropylbenzene and coagents N,N′-(m-phenylene) dimaleamide, trimethylolpropane trimethylacrylate, tetraallyloxyethane, triallyl cyanurate, tetramethylene diacrylate, or polyethylene oxide glycol dimethacrylate.

Poly(meth)acrylate include polymethacrylate, polyacrylate, poly(alkyl acrylate) copolymers can involve two or more alkyl (meth)acrylates (e.g., ethyl acrylate, butyl acrylate, or 2-methoxyethyl acrylate) copolymerized with a cure cite monomer disclosed above. Poly(meth)acrylate can also be compounded, cured, or post-cured as disclosed above or as is well known to one skilled in the art. Because these polymers are well known to one skilled in the art and commercially available, the description of which is omitted herein for the interest of brevity.

ABS copolymer represents acrylonitrile-butadiene-styrene block copolymer, a thermoplastic used to make light, rigid, molded products such as pipes, golf club heads, automotive body parts, enclosures, protective head gear, and toys. It is a copolymer made by polymerizing styrene and acrylonitrile in the presence of polybutadiene in the proportions varying from about 15% to about 35% acrylonitrile, about 5% to about 30% butadiene, and about 40% to about 60% styrene to produce a long chain of polybutadiene criss-crossed with shorter chains of poly(styrene-co-acrylonitrile). The nitrile groups from neighboring chains, being polar, attract each other and bind the chains together, making ABS stronger than pure polystyrene. The styrene moiety makes the plastic a shiny, impervious surface while the butadiene moiety provides resilience even at low temperature such as −25° C. and 60° C. ABS copolymer is well known to one skilled in the art. See, e.g., “ABS Resins”, Kirk-Othmer Encyclopedia of Chemical Technology, 3rd edition, volume 18, John Wiley & Sons, pages 442-449 (1982), for a description of ABS Resins and their method of manufacture.

The composition can also comprise both ABS copolymer and a compatibilizer, to improve the ABS dispersion in the polyamide phase. The compatibilizer can be a hydrocarbon polymer such as functionalized or grafted hydrocarbon polymer comprising repeat units derived from styrene or alkyl styrene and a grating monomer or having grafted thereon a grating monomer and the hydrocarbon polymer comprises repeat units derived from styrene, alkyl styrene, or combinations thereof. Alkyl styrene includes alkyl group having 1 to about 10 carbon atoms such as α-methyl styrene, α-ethyl styrene, α-butyl styrene, β-styrene, β-methyl styrene, or combinations of two or more thereof. Hydrocarbon resins can be produced by any methods well known to one skilled in the art such as cationic polymerization of a styrene, alkyl styrene, or both optionally in the presence of a solvent such as toluene or xylene. Because such methods are well known, the description of which is omitted herein for the interest of brevity. Hydrocarbon polymers also include block copolymers of styrene and one or more conjugated dienes including isoprene, butadiene, or combinations of two or more thereof wherein the block copolymers may be completely or partially hydrogenated to produce a copolymer such as SEBS (styrene-ethylene-butene-styrene) polymer. Other examples include SI (styrene-isoprene), SB (styrene-butadiene), SBS (styrene-butadiene-styrene), BSB (butadiene-styrene-butadiene), SISI, SISB, SBSB, SBSI, ISISI, ISISB, BSISB, ISBSI, BSBSB, BSBSI, or combinations of two or more thereof. Styrenic block copolymers are either commercially available or are well known to one skilled in the art and the description of which is omitted herein for the interest of brevity.

The grafting monomer can include one or more acids, anhydrides, imides, amides, alcohols, derivatives thereof, or combinations of two or more thereof. Anhydride can include an ester of the acid anhydride. Examples of grafting monomers include the acids, acid anhydrides, esters of the acids or acid anhydrides disclosed above. The repeat units of the hydrocarbon polymer derived from a grafting monomer can be about 0.1 to about 50, about 1 to about 30, or about 1 to about 20 weight % of the hydrocarbon polymer.

The composition can include about 1 to about 99 weight % polyamide and about 1 to about 99 weight % modifier. If an ABS is present, the composition can also include about 1 to about 99 weight % ABS. The composition may also include about 0.0001 to about 10 wt % of one or more additives such as antifog agent, plasticizer, processing aide, flow enhancing additive, lubricant, pigment, dye, flame retardant, impact modifier, nucleating agent for increasing crystallinity, antiblocking agent such as silica, reinforcement/fillers such as talc or glass fibers or mica, thermal stabilizer, UV absorber, UV stabilizer, dispersant, surfactant, chelating agent, coupling agent, adhesive, primer, antistatic agent, slip agent, antiblocking agent, or combinations of two or more thereof. The additives may be directly included in the composition or in one or more individual components of the composition. For example, the composition can be made free-flowing by including one or more slip agents or antiblocking agents.

The composition can be produced by any means known to one skilled in the art such as dry blending or melt blending. Dry blending can be accomplished by mixing or tumbling the blend components to form a substantially homogeneous blend. Melt blending can be done either in a batch mode or a continuous mode using conventional melt blending equipment such as a melt extruder or injection molding apparatus.

A modifier can also be mixed with polyamide or with polyamide and ABS, in the presence of a curing agent such as a peroxide, if a co-agent is added for the purpose of cross-linking), a desired filler or additive, and optionally a coagent, and held in a mold at elevated temperature and pressure for a period of time to initiate crosslinking (i.e. curing) and the shaped compositions are then removed from the molds.

The modifier may be either combined directly with the polyamide or with ABS or with one or more additives or pre-melt compounded into a masterbatch formulation. For example, an additive can be blended with an elastomer to prepare a masterbatch that can be added to or combined with the remaining components of the composition in a subsequent blending operation.

Also included in the invention is a masterbatch that comprises a blend of modifier with a polyamide, in which the modifier portion of the blend is crosslinked at least partially to increase its molecular weight and to render the pellets of the blend free-flowing. For the convenience, the invention uses “pellet” to describe the invention, but the invention is also applicable to all physical forms other than pellets. The term “free-flowing pellets” means the pellets can easily be handled with standard feeders for thermoplastics, without bridging causing interruption of the feed. Wishing not to be bound by theory, during the process for producing the masterbatch, polyamide may or may not chemically react with a modifier thereby producing free-flowing pellets. As its molecular weight increases, tackiness and propensity to mass are reduced. Crosslinking can be accomplished by contacting one or more peroxides disclosed above to induce free radicals, formed on the backbone of the modifier, with one or more co-agents disclosed above. Free radicals can be formed by the thermal decomposition of a suitable peroxide in the presence of co-agents bearing 2 to 3 acrylate functionalities (e.g., many Sartomers® commercial products). An example of that family of co-agents is Sartomer® SR231, diethylene glycol dimethacrylate. Cross-linking disclosed herein can be accomplished while making the polyamide-modifier masterbatch by melt blending. Peroxide and co-agent can be combined with, such as by injection into, the polymer melt downstream of the resin feed position, along the barrel of the extruder. The peroxide used can be that having a half life of between about 1 second to about 10, 5, or 3 minutes at the desired processing temperature of the polyamide.

The degree of cross-linking may depend on the relative amounts of modifier and polyamide. The more the polyamide is, the lower the level of cross-linking is required to allow the pellets of the masterbatch flow freely. On the other hand, the higher the concentration of Nylon the less effective it is as a masterbatch to introduce Vamac®. A composition of 25 to 85% Nylon is preferred, more preferably 35 to 75% and most preferably 55 to 65% (note these numbers are best guess only).

A process that can be used to produce the masterbatch is also provided. The process can comprise combining polyamide, a modifier, and optionally one or more additives to produce a mixture; contacting the mixture with a peroxide and optionally a coagent under a condition sufficient to initiate the crosslinking of the modifier and the decomposition of the peroxide. The extent of crosslinking can be partial or complete depending on the end use requirement and the relative concentrations of the modifier and polyamide. Crosslinking can be witnessed by the decrease in melt flow rate of the masterbatch. The process can be carried out in an extruder such as a twin screw extruder. The masterbatch so formed can be pelletized as chopped strands or more effectively, for example, through the use of underwater pelletizing to produce a substantially free-flowing masterbatch. The modifier, peroxide, co-agent, and additive can be as disclosed above. The condition can also include feeding of the polyamide and modifier into the extruder followed by the addition of the peroxide and/or coagent. The mixture can be then heated and mixed to initiate the crosslinking reaction. Once the peroxide is substantially decomposed, volatiles including the decomposition products, can be removed under vacuum. The masterbatch so formed can be pelletized underwater and collected as pellets which can be fed in conventional plastic feeding equipments such as volumetric feeders or loss in weight feeders.

In order to disperse the modifier (partially or fully crosslinked) in the polyamide matrix, the modifier may be crosslinked while intensely mixed with the polyamide and at the processing temperature of the polyamide, the peroxide can have a suitable half life. Wishing not to be bound by theory, if the half life is too long, the decomposition of the peroxide may not be complete resulting in unstable product and, if the half life is too short, it may be insufficient time for modifier to mix well with polyamide. The process produces a masterbatch composition in pellet form, wherein the modifier is finely dispersed in the polyamide phase. When the masterbatch composition is employed for toughening a polyamide, optionally with the ABS copolymer, the compatibilizer, or both, the modifier may or may not be further dispersed depending on the degree of crosslinking. If the modifier is fully crosslinked, it may not be dispersed any further. In this case, the particle size of the modifier particles may stay substantially the same in the final composition. In toughening polyamide, optionally with the ABS copolymer, the compatibilizer, or both, the toughness may depend on the particle size of the modifier or masterbatch. The smaller the particle size of the modifier or masterbatch, the tougher the composition may be. If the modifier is not fully crosslinked, the modifier may further disperse in the composition. A fully crosslinked modifier may have rubber-like characteristics and may provide performance at high temperatures. The particles size may be less than 10, 5, 2, 1, or even 0.5 micron.

Free-flowing masterbatch can be used to combine with polyamide, ABS, and/or the hydrocarbon polymer, each as disclosed above to produce a desired composition.

The composition can be used in a wide variety of industrial applications or industrial articles by any means known to one skilled in the art such as being molded, extruded, cut, injection molded, overmolded, laminated, extruded, milled or the like to provide a desired shape and size. Optionally, articles comprising the conductive thermoplastic composition of this invention may be further processed. For example, portions of the composition (such as, but not limited to, pellets, slugs, rods, ropes, sheets and molded or extruded articles) may be subjected to thermoforming operations in which the composition is subjected to heat, pressure and/or other mechanical forces to produce shaped articles. Compression molding is an example of further processing. Also for example, a film or multilayer film can be produced from a molten composition disclosed herein by a number of methods known in the art (for example, cast film extrusion or blown film extrusion). The film, oriented or non-oriented, can be used for packaging for food, medicine, liquid or solid. The article can include automotive parts (e.g., ignition wire jacketing, spark plug boots, hoses, belts, miscellaneous molded boots, seals, and gaskets). The articles can be produced by forming the composition into the desired shape by, for example, injection molding, compression molding, or transfer molding. They can find their uses in applications as automotive interior or exterior, decorative or structural panels and mouldings, as decorative panels, parts/components of recreational vehicles (e.g. all terrain vehicles, snowmobiles) or computer housings. They can also be used as protective coatings or layers on scuff- and scratch-exposed objects (such as decorative mouldings, auto interior, etc), protective wear layers for sporting goods (such as skis, boots for skiing or skating), exterior coatings of parts for vehicles, decorative laminates, and other objects such as floor coverings. They may also be used for other wear- and scratch-exposed objects such as seal layers in packaging structures that contain hard abrasive objects such as dry soup mixes or the like, transparent scratch-resistant layer on auto interior or exterior applications or flooring tiles or sheets.

The composition or article disclosed also can be laminated to substrates including sheets or films of polymeric materials such as nonwoven materials or nonpolymeric materials such as glass, paper, metal foil, etc. For example, sheets or films comprising compositions of the present invention can be adhered to substrates to provide flooring tiles or sheets by coextrusion, extrusion coating or lamination techniques.

Articles comprising the composition disclosed herein may further comprise other components, such as one or more layers comprising or produced from one or more other polymers to produce a multilayer structure. The article may also be fabricated by extrusion coating or laminating some or all of the layers onto a substrate such as sporting good, automobile interior or exterior, flooring tile or sheet, or packaging film for dry abrasive goods. A multilayer structure can be further processed by thermoforming the structure into a shaped article such as being formed into a casing element for a portable communication device or into a shaped piece that can be included in an automotive part such as a bumper, fender or panel.

Examples of other polymers that can be used include one or more nonionomeric thermoplastic copolymers and/or ionomeric thermoplastic copolymers including copolyetheresters, copolyetheramides, elastomeric polyolefins, styrene diene block copolymers, thermoplastic polyurethanes, poly-ether-ester, poly-amide-ether, polyether-urea, polyesters, polyolefins (e.g., polyethylene, polypropylene, ethylene/propylene copolymer, or metallocene catalyzed PE and copolymer), ethylene copolymers (e.g., vinyl acetate), EPDM, or combinations of two or more thereof, of which are well known to one skilled in the art.

The following example is provided to illustrate the invention.

A reaction mixture containing elastomer (Vamac® VCS 5510; ethylene acrylate elastomer from DuPont; 49.02 parts), peroxide initiator (2,4 dimethyl 2,5-di-t-butylperoxy hexane; Luperox 101 from Arkema; 0.33 parts), coagent (diethylene glycol dimethacrylate, Sartomer SR231, from Saromer; 0.55 parts), and nylon 6 (50 parts Capron 8202L; from Honeywell) was prepared as follows. Peroxide initiator and coagent were dispersed in elastomer (ethylene/acrylate polymer) which had acidic cure sites, in a twin screw extruder, at a temperature (120° C. or 100° C. to 170° C.) high enough to process the elastomer but low enough not to cause any significant decomposition of the peroxide, to produce a mixture. The mixture was then mixed with nylon 6 at high temperature (230° C.) while intensive mixing and kneading were applied to melt and disperse the nylon, while cross-linking was taking place in the elastomer phase, to produce a reaction mixture. Volatiles were then removed from the reaction mixture while heating was continuing to complete the cross-linking reaction reaction. The mixture was then pelletized and dusted with a small amount of partitioning agent, such as talc (0.2 parts), to form free flowing pellets.

1. A composition comprising a polyamide, a modifier, and optionally an ABS copolymer, a compatibilizer, or both wherein
the modifier includes ethylene copolymer, crosslinked ethylene copolymer, ionomer derived from the ethylene copolymer, crosslinked ionomer derived from the ethylene copolymer, poly(meth)acrylate, or combinations of two or more thereof;
the ethylene copolymer comprises repeat units derived from ethylene, at least one alkyl acrylate or (meth)acrylic acid, and optionally an acid cure site monomer;
the acid cure site monomer includes an acid, an acid anhydride, or an ester of the acid, or combinations of two or more thereof and the ester if the acid is a monoalkyl ester;
the compatibilizer includes a hydrocarbon polymer having grafted thereon a grafting monomer; and
the hydrocarbon polymer comprises repeat units derived from styrene, alkyl styrene, or combinations thereof.

2. The composition of claim 1 further comprising one or more additives including flame retardant, antifog agent, plasticizer, processing aide, flow enhancing additive, lubricant, pigment, dye, flame retardant, impact modifier, nucleating agent for increasing crystallinity, antiblocking agent such as silica, reinforcement filler, thermal stabilizer, UV absorber, UV stabilizer, dispersant, surfactant, chelating agent, coupling agent, adhesive, primer, antistatic agent, slip agent, antiblocking agent, or combinations of two or more thereof and the reinforcement filler includes talc, glass fiber, or mica.

3. The composition of claim 1 wherein the composition comprises the polyamide, the modifier, the ABS copolymer.

4. The composition of claim 2 wherein the composition comprises the polyamide, the modifier, the ABS copolymer.

5. The composition of claim 1 wherein the composition comprises the compatibilizer and the grafting monomer is derived from maleic anhydride.

6. The composition of claim 2 wherein the composition comprises the compatibilizer and the grafting monomer is derived from maleic anhydride.

7. The composition of claim 6 wherein the composition comprises the polyamide, the modifier, the ABS copolymer.

8. The composition of claim 3 wherein the additive is talc, mica, glass fiber, or combinations of two or more thereof.

9. The composition of claim 7 wherein the additive is talc, mica, glass fiber, or combinations of two or more thereof.

10. The composition of claim 1 wherein the composition comprises free-flowing pellets wherein

11. The composition of claim 10 further comprising an ABS copolymer, a compatibilizer, or both wherein the compatibilizer includes a hydrocarbon polymer having grafted thereon a grafting monomer.

12. The composition of claim 11 further comprising one or more additives including flame retardant, antifog agent, plasticizer, processing aide, flow enhancing additive, lubricant, pigment, dye, flame retardant, impact modifier, nucleating agent for increasing crystallinity, antiblocking agent such as silica, reinforcement filler, thermal stabilizer, UV absorber, UV stabilizer, dispersant, surfactant, chelating agent, coupling agent, adhesive, primer, antistatic agent, slip agent, antiblocking agent, or combinations of two or more thereof and the reinforcement filler includes calcium carbonate.

13. The composition of claim 12 wherein the additive is talc, mica, glass fiber, or combinations of two or more thereof.

14. An article comprising or produced from a composition wherein
the article includes film or sheet, automotive parts, covering for automotive interior or exterior, decorative or structural panels and mouldings, as decorative panels, parts/components of recreational vehicles, snowmobiles, computer housings, protective coatings or layers on scuff- and scratch-exposed objects, protective wear layers for sporting goods, exterior coatings of parts for vehicles, decorative laminates, seal layers in packaging structures, or flooring tiles or sheets; and
the composition is as recited in claim 1.

15. The article of claim 14 wherein the composition further comprises one or more additives including flame retardant, antifog agent, plasticizer, processing aide, flow enhancing additive, lubricant, pigment, dye, flame retardant, impact modifier, nucleating agent for increasing crystallinity, antiblocking agent such as silica, reinforcement filler, thermal stabilizer, UV absorber, UV stabilizer, dispersant, surfactant, chelating agent, coupling agent, adhesive, primer, antistatic agent, slip agent, antiblocking agent, or combinations of two or more thereof and the reinforcement filler includes talc, glass fiber, or mica.

16. The article of claim 15 wherein the composition comprises the polyamide, the modifier, the ABS copolymer.

17. The article of claim 16 wherein the composition comprises the compatibilizer and the grafting monomer is derived from maleic anhydride.

18. A process comprising combining polyamide, a modifier, and optionally one or more additives to produce a mixture; contacting the mixture with a peroxide and optionally a co-agent under a condition sufficient to partially crosslink the modifier to produce a partially crosslinked masterbatch; and palletizing the partially crosslinked masterbatch to produce a substantially free-flowing masterbatch as recited in claim 7 wherein the modifier is as recited in claim 1 and the additive is as recited in claim 2.

19. The process of claim 18 wherein the process comprises contacting the free-flowing masterbatch with an ABS copolymer, a compatibilizer, or both wherein the compatibilizer includes a hydrocarbon polymer having grafted thereon a grafting monomer.
